(19) United States
(12) Patent Application Publication
(10) Pub. No.: US 2002/0026405 A1
(43) Pub. Date: Feb. 28, 2002

(54) Tradable futures, options, futures on options, options on futures relating to an index on the prices of airline passenger miles

(76) Inventor: Lawrence Haar, Redmond, WA (US)

Correspondence Address: Dr. Lawrence Haar, Apt. F446, 15817 North East 90th Street, Redmond, WA, 98052, US

(21) Appl. No.: 09/895,252

(22) Filed: Jul. 2, 2001

(30) Foreign Application Priority Data
Jul. 12, 2000 (ZA) 2000/3481

(51) Int. Cl. G06F 17/60

(52) U.S. Cl. 705/37; 705/5

(57) ABSTRACT

The prices of airline tickets between fixed points are in general set by a number of cost parameters, including both fixed costs and operating costs, as well as market conditions, which together are difficult to predict. Among operating costs, there are fuel expenditure on various routes, labor costs, and other administrative expenses, including access charges for gates and airports. Fixed costs include aircraft and their financing. Combined with these highly uncertain cost parameters, reflecting the complexity of the business itself, the prices which airlines ultimately set are effected by market conditions including the changing popularity of various routes, seasonal demand and advertising, and competition between various airlines providing services on these and related routes. The unpredictable and complex nature of airline cost structure combined with the vagaries of the market, together suggest, airlines may wish to protect themselves against price uncertainty, and in particular of ticket prices declining. Faced with similar uncertainty, corporations or others who purchase large number of tickets may wish to protect themselves against the price uncertainty, in particular of tickets prices rising. In light of the above, the invention for which this patent application is made concerns a method of pricing and transferring the risks arising from changes in the prices of airline tickets in particular and airline travel in general, which would involve one or more Indices on the prices of airline travel, along with futures, options and other financial products designed to price and transfer risk of changes in the said index or indices. In using the invention, it is envisioned that airlines, corporate buyers of airline tickets, other parties, and those wishing to speculate upon the direction of the prices of airline travel, would take futures and options positions on the said Index or Indices, and by therefore so doing, would eliminate, reduce, or otherwise modify the effects of undesirable and unexpected changes in the prices of airline travel.

### FIELD OF THE INVENTION

This invention relates to a method of managing fluctuations in the prices of airline travel.

### BACKGROUND OF THE INVENTION

The prices of airline tickets between fixed points are in general set by a number of cost parameters, including both fixed costs and operating costs, as well as market conditions, which together are difficult to predict. Among operating costs, there are fuel expenditure on various routes, labour costs, and other administrative expenses, including access charges for gates and airports. Fixed costs include aircraft and their financing. Combined with these highly uncertain cost parameters, reflecting the complexity of the business itself, the prices which airlines ultimately set are effected by market conditions including the changing popularity of various routes, seasonal demand and advertising, and competition between various airlines providing services on these and related routes. The unpredictable and complex nature of airline cost structure combined with the vagaries of the market, together suggest, airlines may wish to protect themselves against price uncertainty, and in particular of ticket prices declining. Faced with similar uncertainty, corporations or others who purchase large number of tickets may wish to protect themselves against the price uncertainty, in particular of tickets prices rising.

### SUMMARY OF THE INVENTION

It is an object of the invention to provide a mechanism by which airlines can protect themselves against uncertain and falling ticket prices on a particular route and users can protect themselves against uncertain and rising prices for travelling on a particular route.

I propose creating one or more Indices related to the prices charged for airline tickets on various routes, respective to various dates, which would be traded on either a new or established Exchange to which airlines and users, and related parties, would be connected preferably by computers or related means. Through the use of agents and brokers, the aforementioned parties would trade, purchase, and sell such Indices, and financial products related to such indices. As illustrated below, such Indices will be computed as weighted averages of the prices charged by various airlines on various routes for travel on specific dates. As illustrated below, the weighting scheme will be based upon the number of seats offered by the respective airlines flying a particular route. Through the purchasing of Futures (that is, the obligation to sell or purchase quantities of the Index in the future at an agreed price, on an agreed date), Options (that is, the right to purchase or sell quantities of the Index at an agreed price on an agreed date) and other derivative financial products on the said Indices, airlines, their customers, and other users would be able to undertake steps to protect themselves if the price of airline tickets were to move in a direction perceived as undesirable over time. Using futures or options on the Indices, the airlines would take positions on said Indices which are off-setting to their underlying exposure in the selling of tickets to passengers, thereby allowing gains in the futures market to off-set losses in the actual ticket market. Thus for example, while an airline would lose from the prices of tickets falling, by having taken an opposite futures or options position on the proposed Index or Indices, it would enjoy an off-setting gain. Similarly, using futures or options on an Index or Indices, buyers of tickets will take positions which are off-setting to their underlying exposure. Thus for example, while a corporate purchaser of airline tickets would lose if prices over time were to increase, by having taken a futures or options position on the proposed Index or Indices, it would enjoy an off-setting gain. A user having purchased futures or options on the Index or Indices, will gain if its price rises. If the perceived as undesirable movement in prices were not to occur, a loss would occur on the Index or Indices futures position(s), as settled financially through the Exchange, although the movement in the actual ticket market prices would be compensating. Thus, if the Index or Indices were to fall, a purchaser of airline tickets would pay into the exchange but would be compensated by the declining prices of tickets, as would be purchased independently of the transaction on the index. Similarly, if the option position on the Index were not usable or exercisable in a profitable manner, the option would expire worthless and the premium expended upon it would have been lost. Regardless of whether the movement in the Index or Indices were desirable from the standpoint of the purchaser, that is off-setting to losses in the airline ticket market itself, as the position in the Index matures, the user of Index Futures, such as an airline or corporate purchaser, would close or unwind the position, using opposite transactions in futures markets. Similarly, in the case of options on the proposed Index or Indices, users will either exercise the option if its strike price is favourable in relation to the market price, or they will allow it to expire if it has no intrinsic value. In the case of both futures and options position on the said Indices, we emphasize that delivery is purely a matter of financial settlement, reflecting gains or losses on the position taken, unlike futures or options on physical commodities, were actual futures and options market may be used for actual delivery. Sets of activities, buying and selling futures or options position on the proposed Index or Indices would be regarded as form of ‘hedging’ activity. Sets of activities buying or selling futures or options position on the proposed Index or Indices purely for gain, without an underlying exposure to the prices of airline travel, would be regarded as a form of ‘speculative’ activity.

As introduced above, I propose one or more Index or Indices on which the transactions mentioned above are based. The index is to be a weighted average of the ticket prices on the particular route at a particular period, normally one day, although a mid-week Index or an over-Saturday Index, or Indices for certain travel seasons, might be useful variants. In averaging across the prices charged by various airlines on specified routes for specified dates, a weighting scheme based upon the number of seats offered would be utilized. The index will be calculated against a figure on a particular day chosen arbitrarily and for which the weighted average will be stated to be an index figure of 100. As a matter of practicality, Futures or Options Contracts in the Index would be for a specified number of seats, such as one-hundred.

A number of non-limiting examples are quoted for the purpose of illustrating the invention.

An Exchange is established or would be utilized upon which the Index or Indices on the prices of airline travel would be quoted, and against which futures and options positions would be traded. Using information technology, various hedgers and speculators, as well as arbitrageurs, would be connected, using agents and brokers. The Exchange or its duly authorized body, would have the responsibility to compute the Index or Indices for specified routes, for specified dates, on a regular basis, and to publish the said Index or Indices on a regular basis, using information technology or other means of dissemination. As such the Index would be ‘quoted’ on the Exchange. Contracts in the Index would be quoted in ‘round-lots’, arbitrarily set for a specific number of seats, such as one-hundred. The index is the weighted average of the prices charged by various airlines on specified routes for specified dates. An example of how the Index is computed is given below.

The illustrated index is that for flights between London and New York return. For the purpose of this illustration it is assumed that there are four carriers, viz. Airlines A, B, C and D. (There are of course in reality many other carriers and many other flights all of which will contribute to calculation of the Index for a specific date route in practise, but in order to illustrate the position in a concise way four hypothetical carriers will be considered in this example). The details of their services and prices at an arbitrary date, say Jan. 3, 2002 for travel on Apr. 3, 2002 are as follows:

| Carrier | No Flights | Seats per flight | Price per Seat |
|---|---|---|---|
| Carrier A | 5 | 200 | $400 |
| Carrier B | 10 | 220 | $350 |
| Carrier C | 7 | 250 | $300 |
| Carrier D | 3 | 250 | $320 |

For illustration, it will be seen that the carriers are offering the following number of seats on Jan. 3, 2002 for travel on Apr. 3, 2002:

| Carrier | Total Number of Seats offered | |
|---|---|---|
| Carrier A | 5 × 200 = | 1000 seats |
| Carrier B | 10 × 220 = | 2200 seats |
| Carrier C | 7 × 250 = | 1750 seats |
| Carrier D | 3 × 250 = | 750 seats |
| TOTAL | | 5700 seats |

Calculation of Weighted Average (WA)

$$\begin{matrix}WA = \{ ( 1000 / 5700 ) \times \$400 \} + \{ ( 2200 / 5700 ) \times \$350 ) + \\ \{ ( 1750 / 5700 ) \times \$300 ) + \{ ( 750 / 5700 ) \times \$320 \}\end{matrix}$$

$$WA = \$72 + \$136 .50 + \$93 + \$41 .60$$

$$WA = \$343 .10$$

Calculation of Index

On an arbitrarily chosen date, conveniently one year previously (i.e. Jan. 3, 2001) the weighted average for the same flight three months hence is chosen as an Index figure of 100. Say that weighted average is $300. Therefore the Index figure for Jan. 3, 2002 is the weighted average at Jan. 3, 2001 divided by the weighted average at Jan. 3, 2002 multiplied by 100 and rounded up or down to the nearest whole number i.e. ($343.10/$300)×100=114, that is $3.00 per Index Point ($343/114=$3.00). Assuming Contracts in the Index are for round-lots of one-hundred seats and $3.00 per Index Point, we would have a contract value at the current WA of $34,310 corresponding to an Index value of 114.

Operation of the Exchange on which the Index or Indices would be Traded

I By an airline

Assume in early January 2002, Airline A fears that the prices of tickets for a flight departing on Apr. 3, 2002 will fall during the next three months. It has not yet sold all of the seats it is planning to have available, which by assumption and for purposes of illustration, we set at 1000 (one-thousand). Under such a scenario, to protect its revenues, it would enter into a future transactions on the relevant Index selling it in advance for financial settlement. (We emphasise that the such transactions are always settled purely financially, as a futures or options position on an Index, unlike that on a corn or petroleum, cannot actually be delivered in a physical sense.) Or similarly, the airline might purchase Put Options on the said Index, giving it the right to sell the Index at a specified price, with relevance to the specified date. The size of the position taken in the Index, using futures or options, or some combination of the two, would be designed so that the movement in the Index would be off-setting to losses arising in the actual ticket market between early January 2002 and Apr. 3^{rd}, 2002. Assuming the airline decides to fully protect its position, it would sell the Index as computed for the specific destination and date, at the quoted Index price on Jan. 3, 2002. (The futures transaction would occur through the Exchange and would involve one or more counter-parties taking, in sum, an equal and off-setting position. That is, since the airline has sold a futures position on the Index, there would be one or more parties purchasing one or more futures positions on the said Index for the specified date and route.) As we have assumed that each future contract in the Index is for 100 (one-hundred) seats, and the airline wishes to fully hedge the position, it would enter into 10 (ten) futures transactions, (i.e. 1000 seats), at the present Index level of 114, of value $343,000 (three hundred and forty three thousand Dollars), which is equivalent to a per seat price of $343.00 on Weighted Average (WA) calculation. Assume the Index is sold in a futures transaction, through the Exchange at the said price. Now suppose further, that the prices of tickets for the Apr. 3, 2002 flight on the specified route, dropped to a Weighted Average (WA) value of $321, i.e. the Index is now {($321/$300)×100} i.e. 107. (The ratio of $3.00 per Index Point remains constant.) The value of the 1000 seats will now be $321,000. Showing the nature of financial settlement, the Exchange will pay Airline A for the difference i.e. $22,000. Although the actual prices at which airline tickets for the specified route and date, sold over the next three months prior to the April 3^{rd} departure fell, the airline would have been compensated by the gain in the futures market position. The loss in the airline ticket market, that is ($321-343)*1000=$22,000

Note that the airline will continue to sell the tickets on its relevant flights at prices prevailing at the time, through its chosen means, on-line booking, travel agents, etc. Such actual or physical transactions will be separate and independent of the transactions on the Exchange which are settled financially and involve no actual delivery of airline tickets, as noted previously.

II By a User

Assume a potential buyer of a substantial number of airline tickets for a flight on or after Apr. 3, 2000 fears that the price of tickets will rise. It would then use the Exchange to purchase futures on the relevant Index for such flights at the price quoted on Jan. 3, 2002 for settlement on Apr. 3, 2002. Similarly, it might purchase call options on the relevant Index giving the right to purchase the Index on or before Apr. 3, 2002. To be fully hedged, the buyer would purchase the Index in quantities sufficient to equal the underlying exposure on actual number of seats offered. Suppose, the user were to purchase three Index contracts, representing by assumption, 300 seats, at an Index value of 116, equivalent to a price per ticket of $348.00 (three hundred forty eight Dollars), for three-hundred seats, giving a total of $104,400 for three one hundred seat contracts. Recall, given our assumption on the computation of the Index from a base of one-hundred, equivalent to a Weighted Average (WA) price of $300, an Index value of 116 would correspond to an individual ticket price of $348. (Further, we continue to assume that for this specific Index, one point corresponds to $3.00.) Having entered into the futures transaction on the Index, assume further that the weighted average of the prices of the tickets at Apr. 3, 2002 were to rise equivalent to a WA of $354, i.e. the Index is now {($354/$300)×100} i.e. 118. The value of the 300 seats will now be $106,200. Although in the actual cash market the user will now be paying more for tickets purchased, the exchange will reward the user for the difference i.e. $1,800.

Note that the user will continue to buy the tickets it requires at prices prevailing at the time. Such transactions will be separate and independent of the transactions on the Exchange. The futures transaction on the Index will be settled with the exchange on a financial basis, not involving any actual sale or purchases of actual tickets.

III By a Speculator and Arbitrageur

Speculators will be parties who are willing to assume a risk for a certain amount of money as would arise from the futures and options transactions explained and mentioned above if the market had not moved in the directions feared by the hedgers, or from selling options positions to hedgers, in anticipation that the options would not be exercised, that is they are not in-the-money, having no intrinsic value. Thus in example I above, if a speculator(s) believe(s) the Index will rise and not fall, it would be the opposite party to the airline with the Exchange acting as an intermediary. In the case of the buyer of the Index, example II, the speculator(s) would be one or more parties believing that the prices of tickets will fall in the future, rather than rise. The prices at which futures and options on the said Indices trade reflect the price at which speculators are willing to accept risk.

If as set out in example I the Index drops, the Speculator having sold a futures position on the Index, would have to pay into the Exchange the difference arising from the fall in the Index. Such amounts, as made available from speculators, collectively through the Exchange will provide the source of financial settlement with the airlines who sold the Index. Of course if the Index rises, then the airline must pay in to the Exchange which will reimburse the Speculator. A similar or analogous position will apply if the Speculator enters into a selling position on the futures Index with the user, as found in Example II, By a User. With regard to options positions on the Indices, Speculators would receive premium income for having sold a Put (the right to sell the Index) or a Calls (the right to purchase the Index) at a specified price on or before a specified date.

Arbitrage opportunities, that is the process of minimising pricing inconsistencies between related markets, may arise in the purchasing, selling and trading of the said Index or Indices. A non-limiting example of such arbitrage opportunities may arise when the WA Index on combined destinations, for example, London to New York and New York to Los Angeles versus London to Los Angeles directly, imply different prices for essentially the same service.

IV General

The Exchange(s) on which the Index or Indices are quoted and on which futures and options on such Index or Indices are traded, will maintain a list of persons with whom it will deal. These may be airlines and general users or may be agents and brokers accredited to the Exchange who will act on behalf of clients such as airlines and general users. Further, the airline will create terms and conditions for third parties wishing to speculate, using futures, options on the published Indices. All these persons will be connected to the Exchange preferably using information technology to the main server operated by the Exchange.

The Exchange will charge a commission on all dealings made through it. Further the Exchange will maintain such arrangements to ensure timely and proper execution and settlement by the relevant parties. Such settlement will take place on a date related to the date of the relevant flight being such date or a period thereafter, say one week. Such settlement on Futures, Options and other derivative products relating to the Index will be purely financial, that is depending upon whether the position has any value. It will be the duty of the Exchange or its duly authorized representative to ensure the credit worthiness of hedgers, speculators and other users of the Exchange, to ensure solvency and liquidity of the market.

It will be understood that the Exchange will offer Indices quoted on any particular routes provided there are sufficient numbers of operator and flights to enable a proper index for that route to be computed and maintained and there is sufficient uncertainty on the direction of futures prices to merit the management of exposure by hedgers, be they airlines or large users.

It will be understood further that the Index may be calculated for say (a) regional flights, e.g. (i) all flights between the United Kingdom and the USA, (ii) all flights between Europe and the Antipodes (i.e. Australia and New Zealand) and (iii) the USA and a region comprising China, Taiwan, Korea and Hong Kong, (b) all local flights within the United States or within Europe and (c) all international flights. The calculations for such Indexes will be carried out in the same manner as that described above. The calculations will be more complex in that there will be more data that will have to be considered. Always, the design and computation of the Index or Indices, relevant to specific routes for specific dates through-out a year, will accurately reflect prices charged on said routes for said dates, by the airline carriers. The Index or Indices may be computed for Economy, Business-Class, and First Class travel.

The Exchange will retain information, storing it electronically or by other means, about the Indices which may be obtained only from the server, computers and other information technology maintained by the Exchange.

In the computing of Index values from the WA calculations shown above, and facilitating the purchase and sale of futures and options positions on said Indices, there is no constraint on the volume of such hedging and speculating transactions and may exceed the actual quantity of seats offered for specified dates on specified routes. (The phenomenon of futures and options positions on underlying markets greatly exceeding the underlying physical markets, in this case airline tickets, is common to other derivative markets, be they commodities, bonds, equities, or other securities.)

I claim:

1. A method of reducing the risk to providers of airline tickets and users of such tickets arising from price fluctuations comprising an Exchange through which such providers and users as well as speculators and arbitrageurs can enter into futures and options transactions relating to prices charged for airline travel and an index or indices for predetermined periods of time being the weighted average for the prices of flight tickets between specified locations.

2. A method as claimed in claim 1 in which said Exchange incorporates and uses information technology to and through which the providers, users and speculators can communicate with regard to purchasing and selling of positions on the Index or Indices, as well as learn of the values, both historic and latest, of the said Index or Indices.

3. A method as claimed in claim 2 in which the index(ices) is computed and quoted using information technology.

4. A method as claimed in claim 1 in which the Exchange charges persons using the Exchange a commission on transactions made through the Exchange relating to said Index or Indices of claim 1.

5. A method as claimed in claim 1 wherein said determined locations are two airports.

6. A method as claimed in claim 1 wherein said determined locations are two regions.

7. A method as claimed in claim 1 wherein the determined locations are all predetermined airports between which aircraft fly.

8. A method as claimed in claim 1 wherein the said periods are particular days.

9. A method whereby a seller of airline tickets can protect itself against losses due to the prices of airline tickets between specified locations falling on or before a future date, comprising communicating through an Exchange with buyers of airline tickets wishing to protect themselves against losses due to the prices of airline travel between specified locations increasing, or other parties wishing to speculate on the value(s) of the Index or Indices, and which involves an Index or Indices for predetermined periods being the weighted average for flight tickets between said locations; offering through said Exchange to sell futures or options on the Index or Indices for such future dates at a price corresponding to a magnitude prevailing at the date of sale;
settling with the Exchange within a specified time period related to the prices of an Index or Indices on a future date, such settlement consisting of:
paying in monies relating to the Index or Indices on or before the said future contract expiry date if this rises relative to the said Index at the date of offer; or
receiving monies from the Exchange relating to the Index on or before the said future contract expiry date if this falls relative to the said Index at the date of the offer.

10. A method as claimed in claim 9 in which the Exchange uses computer technology and the sellers of airline tickets and the buyers of airline tickets and speculators on the Index or Indices of uses their respective information technologies to communicate through the Exchange, using brokers and agents as required, with regard to the purchasing and selling of futures and options position on said Index or Indices, as well as to learn of the values at which the Index or Indices are being quoted and being traded, and other such information which buyers and sellers of airline tickets, and other parties such as speculators would find of relevance.

11. A method as claimed in claim 9 wherein said date related to the said future date is the same date as said future date.

12. A method as claimed in claim 9 wherein said date related to the said future date is a date a predetermined number of days after said future date.

13. A method whereby a user of airline tickets can protect itself against losses due to the cost of airline tickets between two locations rising on or before a future date, comprising communicating with an Exchange through which such users can communicate with speculators and which provides an index for predetermined periods being the weighted average for flight tickets between said locations; offering through said Exchange to take a futures, option or other derivative position on the Index or Indices for a date in the future date prevailing at the date of the offer; settling with the Exchange within a specified time period related to the said Index or Indices future date, such settlement consisting of:
paying in monies relating to the Index at the said future date if this falls relative to the said Index at the date of offer; or
receiving monies from the Exchange relating to the Index at the said future date if this rises relative to the said Index at the date of the offer.

14. A method as claimed in claim 13 in which the Exchange has a main computer and other information technology and the user, buyers or sellers of futures positions on the Index or Indices or buyers or sellers of options on the Index of Indices, as well as their designated agents and brokers, have their own computers, and other information technology, through which communication occurs between buyers, sellers, and the Exchange.

15. A method as claimed in claim 14 wherein said date related to the said future date is the same date as said future date.

16. A method as claimed in claim 14 wherein said date related to the said future date is a date a predetermined number of days after said future date.

17. One or more Index or Indices computed using the number of seat weighted average(s) re-based to an arbitrary value, such as one-hundred (100), which show the prices of airline travel on specified dates between specified destinations, and through its adjustment over time to reflect changes in prices on offer, will show changes in the prices of airline travel, between specified destinations on specified dates.

18. A method whereby a speculator on the prices of airline tickets may take risky positions for uncertain future gain arising from movements in the prices of airline tickets between two locations increasing or decreasing on or before a future date. Such speculative activity would involve communicating by way of an Exchange, using brokers and agents where applicable, through which such speculators can enter into transactions with airline users and airlines and which provides an index for predetermined periods being the weighted average for flight tickets between said locations; offering through said Exchange to take a futures, option or other derivative position on the Index or Indices for a date in the future date prevailing at the date of the offer;
settling with the Exchange within a specified time period related to the said Index or Indices future date, such settlement consisting of:
paying in monies relating to the Index at the said future date if this falls relative to the said Index at the date of offer; or
receiving monies from the Exchange relating to the Index at the said future date if this rises relative to the said Index at the date of the offer

19. Futures, Options, Futures on Options, Options on Futures and other such derived or derivative securities relating to said Index or Indices which may be traded, bought, sold, as claimed in 17, on or through the Exchange, as claimed in claim 1, for the purposes of hedging, speculating, arbitrage, as per claim 1.
